(19) United States
(12) Patent Application Publication
(10) Pub. No.: US 2013/0036988 A1
(43) Pub. Date: Feb. 14, 2013

(54) PET CHEW SNACK

(71) Applicant: Chih-Cheng LAI, Taipei (TW)

(72) Inventor: Chih-Cheng LAI, Taipei (TW)

(21) Appl. No.: 13/207,879

(22) Filed: Aug. 11, 2011

(51) Int. Cl. A01K 29/00

(52) U.S. Cl. 119/709

(57) ABSTRACT

A pet chew snack has a winding belt and a body. The winding belt is edible. The body is solid, chewable and edible and has a helical slot and at least one hole. The helical slot is helically formed in and distributed across the middle portion. Each one of the at least one hole is located at one of the end portions for one end of the winding belt to be mounted therein. The winding belt is replaceably mounted in the at least one hole and the helical slot. As the winding belt is received in the helical slot and the at least one hole of the body, it takes pets longer time to consume the winding belt. Moreover, the winding belt is replaceable. Accordingly, the pet chew snack prolongs attraction to pets in chewing the body by having the winding belt.

### BACKGROUND OF THE INVENTION

1. Field of the Invention

The present invention relates to a pet chew snack, and more particularly to a pet chew snack having an edible portion helically mounted in a solid, chewable and edible portion for prolonging chewing desire of pets.

2. Description of the Related Art

Pet chews serve for pets to chew so as to ease the sore of gums and jaws of pets when they are teething and get additional snack supplement besides the regular meals. For the purpose of whetting pets' desire in biting and chewing, pet chew snacks develop from being plain pet chews to provide additional snack portions on the bodies of the pet chews.

However, the snack portions of conventional pet chew snacks are usually wrapped around and not securely mounted on the bodies of pet chews. After pets bite and chew the snack portions, the snack portions are consumed or come off easily from the bodies of the pet chew snacks and the pet chew snacks soon degrade their value to become regular pet chews having no add-on attraction in luring pets to bite and chew. Since the snack portions of the conventional pet chews are not replaceable, pets get bored with the less tasteful pet chew snacks and the pet chew snacks are discarded shortly.

### SUMMARY OF THE INVENTION

An objective of the present invention is to provide a pet chew snack having an edible portion helically mounted in a solid, chewable and edible portion for prolonging chewing desire of pets.

To achieve the foregoing objective, the pet chew snack has a winding belt and a body.

The winding belt is edible.

The body is solid, chewable and edible and has two end portions, a middle portion, a helical slot and at least one hole.

The middle portion is integrally formed between the two end portions.

The helical slot is helically formed in and distributed across the middle portion.

Each one of the at least one hole is formed in one of the end portions for fixing one end of the winding belt.

The winding belt is replaceably mounted in the at least one hole and the helical slot.

Since the winding belt is received in the two holes and the helical slot of the body, the winding belt is not easily finished off. Even after a winding belt is fully consumed, a new winding belt with a same or different flavor can be added again. Therefore, with the winding belt arousing pets' chewing desire and serving as a snack, pets' fun in chewing the body and having additional snack supplement can be combined as a whole and prolonged.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pet chew snack in accordance with the present invention;

FIG. 2 is an exploded side view of the pet chew snack in FIG. 1;

FIG. 3 is a top view in partial section of the pet chew snack in FIG. 1;

FIG. 4 is a top view in partial section of a second embodiment of a pet chew snack in accordance with the present invention;

FIG. 5 is a top view in partial section of a third embodiment of a pet chew snack in accordance with the present invention;

FIG. 6 is an exploded side view of a fourth embodiment of a pet chew snack in accordance with the present invention;

FIG. 7 is a top view in partial section of the pet chew snack in FIG. 6; and

FIG. 8 is a top view in partial section of a fifth embodiment of a pet chew snack in accordance with the present invention.

### DETAILED DESCRIPTION OF THE INVENTION

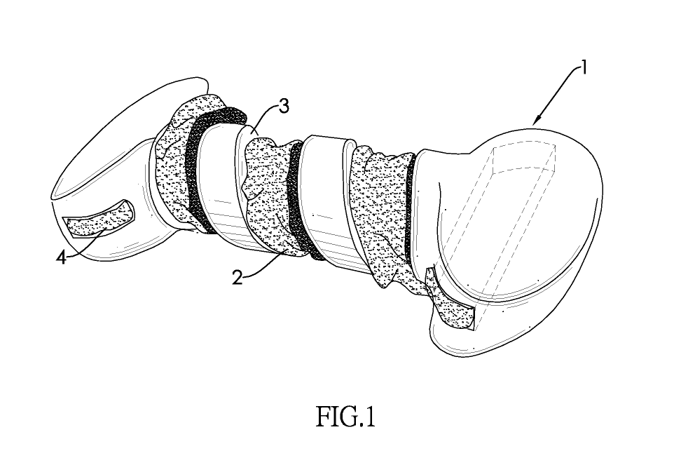

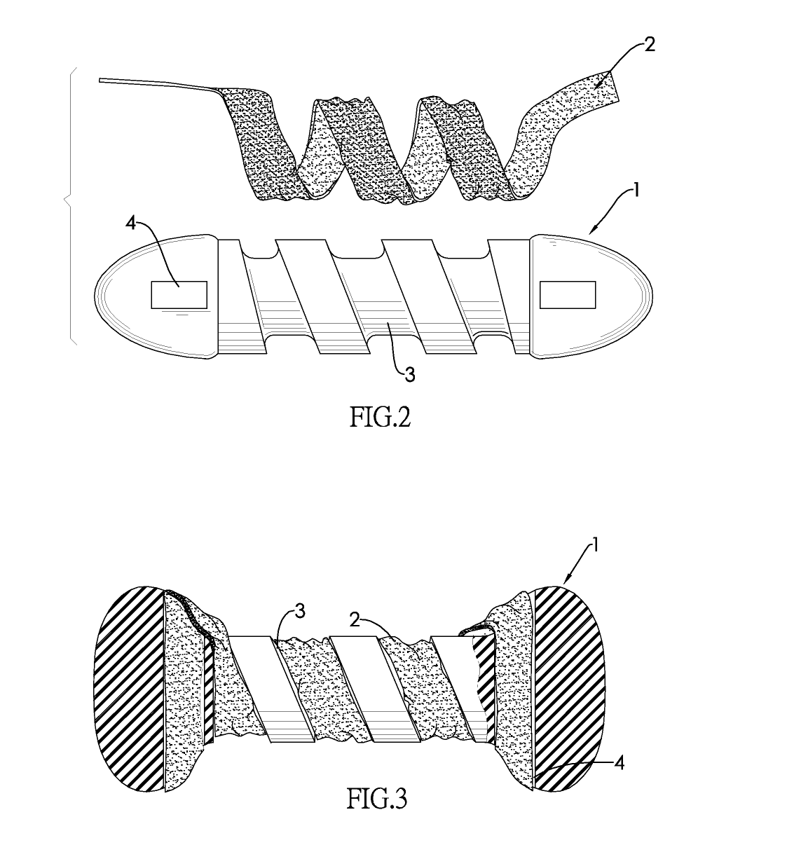

With reference to FIGS. 1 to 3, a first embodiment of a pet chew snack in accordance with the present invention has a winding belt 2 and a body 1. The winding belt 2 is edible, may be made of rawhide or meat product such as meat strip, and may be added with flavorings so that the winding belt 2 can taste like chicken, bacon and the like.

The body 1 is solid, chewable and edible, and may be made of cornstarch. The body 1 may take a form of a shape to attract attention of pets. In the present embodiment, the body 1 takes the form of a dumbbell. The body 1 has two end portions, a middle portion, a helical slot 3 and at least one through hole 4. The middle portion is integrally formed between the two end portions. The helical slot 3 is helically formed in and distributed across the middle portion. Each one of the at least one through hole 4 is formed through one of the end portions for one end of the winding belt 2 to be mounted therein. In the present embodiment, the body 1 has two through holes 4. The winding belt 2 sequentially penetrates through and is replaceably mounted in one of the two through holes 4, the helical slot 3 and the other through hole 4.

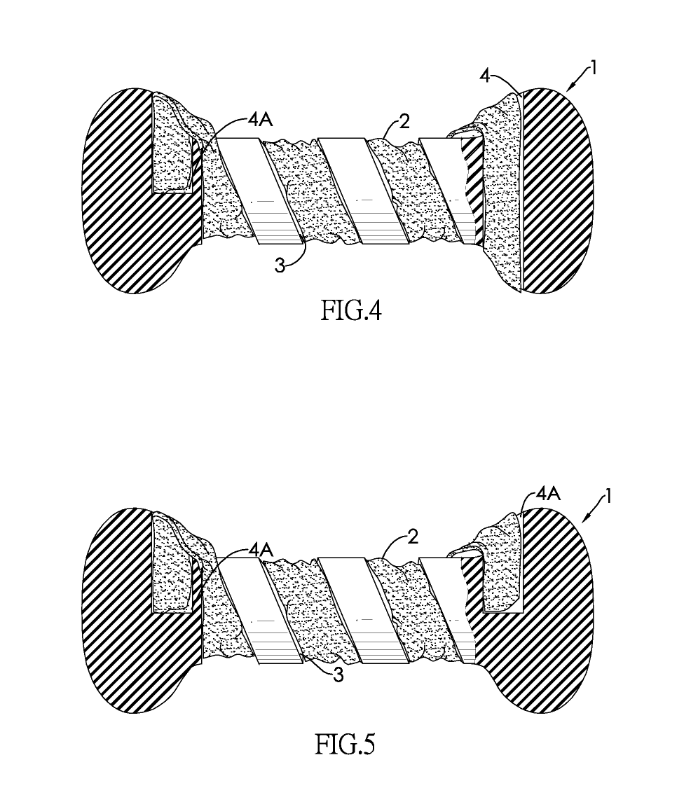

With reference to FIG. 4, a second embodiment of a pet chew snack in accordance with the present invention is shown and differs from the forgoing embodiment in having one through hole 4 and one blind hole 4A. The through hole 4 is formed through one of the end portions of the body 1 and the blind hole 4A is formed in the other end portion. The winding belt 2 is replaceably mounted in the through hole 4, the helical slot 3 and the blind hole 4A.

With reference to FIG. 5, a third embodiment of a pet chew snack in accordance with the present invention is shown and differs from the foregoing embodiments in having two blind holes 4A. Each blind hole 4A is formed in one of the end portions of the body 1. The winding belt 2 is replaceably mounted in one of the blind holes 4A, the helical slot 3 and the other blind hole 4A.

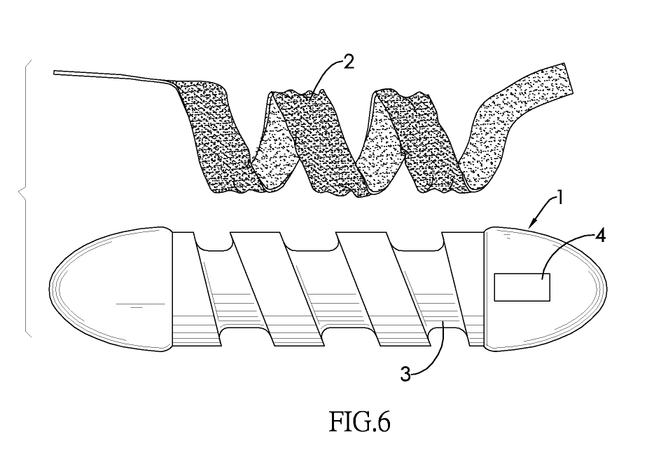

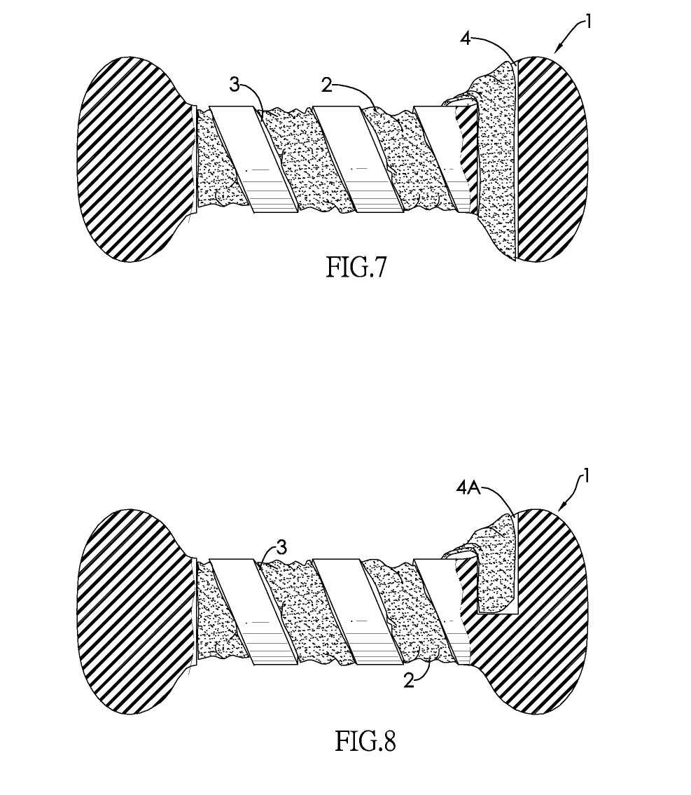

With reference to FIGS. 6 and 7, a fourth embodiment of a pet chew snack in accordance with the present invention is shown and differs from the foregoing embodiments in having only one through hole 4 formed through one of the end portions. The winding belt 2 sequentially penetrates through and is replaceably mounted in the through hole 4 and the helical slot 3.

With reference to FIG. 8, a fifth embodiment of a pet chew snack in accordance with the present invention is shown and differs from the foregoing embodiments in having only one blind hole 4A formed in one of the end portions. The winding belt 2 is replaceably mounted in the helical slot 3 and the blind hole 4A.

When chewing the pet chew snack, a pet can chew the body 1 so that the body 1 can be chewed on by pets and swallowed after the body 1 is bitten into small pieces. Meanwhile, the pet can lick, bite and swallow the winding belt 2. After most of the winding belt 2 is finished off by the pet, a winding belt 2 having a flavor same as or different from that of the consumed winding belt 2 can be supplied so that pets' desire in terms of biting, chewing, licking and swallowing the pet chew snack can be aroused again.

The body 1 of the pet chew snack serves as a chewable part same as that of a conventional pet chew. As two ends or one end of the winding belt 2 is received in an option among the two through holes 4, one through hole 4 and one blind hole 4A, two blind holes 4A, one through hole 4 only or one blind hole 4A, and the rest of the winding belt 2 is received in the helical slot 3 of the body 1, it takes longer time for pets to finish off the winding belt 2. Moreover, after a winding belt 2 is eaten up, a new winding belt 2 with a same or different flavor can be added again. Accordingly, with the winding belt 2 serving as a snack, pets' fun in chewing the body 1 and having additional snack supplement can be combined as a whole and last longer.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pet chew snack comprising:
a winding belt being edible; and
a body being solid, chewable and edible and having:
two end portions;
a middle portion integrally formed between the two end portions;
a helical slot helically formed in and distributed across the middle portion; and
at least one hole, each one of the at least one hole located at one of the end portions for one end of the winding belt to be mounted in the hole;
wherein the winding belt is replaceably mounted in the at least one hole and the helical slot.

2. The pet chew snack as claimed in claim 1, wherein the body has a single one through hole formed through one of the end portions; and
the winding belt sequentially penetrates through and is replaceably mounted in the through hole and the helical slot.

3. The pet chew snack as claimed in claim 1, wherein
the body has a single one blind hole formed in one of the end portions; and
the winding belt is replaceably mounted in the blind hole and the helical slot.

4. The pet chew snack as claimed in claim 1, wherein the body has two through holes respectively formed through the end portions; and
the winding belt sequentially penetrates through and is replaceably mounted in one of the through holes, the helical slot and the other through hole.

5. The pet chew snack as claimed in claim 1, wherein
the body has:
one through hole formed through one of the end portions; and
one blind hole formed in the other end portion; and
the winding belt is replaceably mounted in the through hole, the helical slot and the blind hole.

6. The pet chew snack as claimed in claim 1, wherein
the body has two blind holes respectively formed in the end portions; and
the winding belt is replaceably mounted in one of the blind holes, the helical slot and the other blind hole.

7. The pet chew snack as claimed in claim 1, wherein the winding belt is made of rawhide and is added with flavorings to have a chicken flavor.

8. The pet chew snack as claimed in claim 2, wherein the winding belt is made of rawhide and is added with flavorings to have a chicken flavor.

9. The pet chew snack as claimed in claim 3, wherein the winding belt is made of rawhide and is added with flavorings to have a chicken flavor.

10. The pet chew snack as claimed in claim 4, wherein the winding belt is made of rawhide and is added with flavorings to have a chicken flavor.

11. The pet chew snack as claimed in claim 5, wherein the winding belt is made of rawhide and is added with flavorings to have a chicken flavor.

12. The pet chew snack as claimed in claim 6, wherein the winding belt is made of rawhide and is added with flavorings to have a chicken flavor.

13. The pet chew snack as claimed in claim 1, wherein the winding belt is made of rawhide and is added with flavorings to have a bacon flavor.

14. The pet chew snack as claimed in claim 2, wherein the winding belt is made of rawhide and is added with flavorings to have a bacon flavor.

15. The pet chew snack as claimed in claim 3, wherein the winding belt is made of rawhide and is added with flavorings to have a bacon flavor.

16. The pet chew snack as claimed in claim 4, wherein the winding belt is made of rawhide and is added with flavorings to have a bacon flavor.

17. The pet chew snack as claimed in claim 5, wherein the winding belt is made of rawhide and is added with flavorings to have a bacon flavor.

18. The pet chew snack as claimed in claim 6, wherein the winding belt is made of rawhide and is added with flavorings to have a bacon flavor.
